(19) United States
(12) Patent Application Publication
(10) Pub. No.: US 2007/0169589 A1
(43) Pub. Date: Jul. 26, 2007

(54) Replaceable assembly of tool head

(76) Inventor: Chih-Ching Hsieh, Taichung City (TW)

Correspondence Address: CHIH-CHING HSIEH, 235 CHUNG-HO BOX 8-24, TAIPEI, ROC, TW

(21) Appl. No.: 11/336,769

(22) Filed: Jan. 23, 2006

(51) Int. Cl. B25B 23/16; B25G 1/00

(52) U.S. Cl. 81/177.1; 81/177.85

(57) ABSTRACT

A replaceable assembly of a tool head comprises a tool body used with a tool head of various forms; the tool body having a handle; at least one end of the handle being formed with a pivotal end for connecting the tool head; one end of the tool head being a driving opening and another end thereof being formed with an inserting end; the inserting end being installed with a buckling unit; the buckling unit being buckled to the pivotal end so as to increase the combination of the pivotal end and the pivotal end; thereby the tool head can be firmly secured to one end of the handle; one lateral wall of the pivotal end of the handle having a through hole for buckling the buckling unit of the inserting end of the tool head; and a periphery of the through hole being formed with a groove.

### FIELD OF THE INVENTION

The present invention relates to hand tools, and in particular to a replaceable assembly of a tool head, wherein the defects of difficult connection of the tool head and handle, complicated structure, and weak connection are improved.

### BACKGROUND OF THE INVENTION

Screwing tools are widely used in industry or homes. Since there are many kinds of objects necessary to be screwed, there are various kinds of the screwing tools are necessary. Thus, a replaced screwing tool is designed, which can suit various sizes of heads. Thus the user only prepares one handle and a plurality of replaceable heads. The cost is lowered and the storing space for the tool is saved. In this design, the buckling structure for connecting the tool heads to the handle is very important. If the head is too heavy, it is possible that the head will fall down.

An improved structure illustrated in FIGS. 7 to 9 is disclosed. In the structure, a handle 90 of a tool has one end having a pivotal end 91 for assembling a tool head 92. The tool head 92 has a buckling unit 93 formed by a spring and a resisting element. The resisting element 93 can resist against the through hole 94 of the pivotal end 91 so that the tool head 92 will not separate from the handle 90. To support a heavy object, the buckling unit 93 is an elastic unit with a greater elastic coefficient. It is firmly secured to the pivotal end 91. If it is desired to take out the too head 92, a push unit 95 pushes the resisting element 93 of the tool head 92 to be out of the through hole 94 of the pivotal end 91. Therefore, the tool head 92 can be separated and taken out. Since the push unit is separated from the body of the tool, it is a trouble in operation and storage.

Moreover referring to FIG. 9, a groove 96 is formed in the tool head 92. A buckling plate 97 is pivotally installed to the pivotal end 91. By the combination and separation of the buckling plate 97 and the groove 96, the connection of the tool head 92 and the pivotal end 91 is controlled. However this prior art has a defect of low precision and weak connection of the buckling of the tool head. In adjustment, it is difficult to move the buckling plate outwards to separate the tool head. Thereby it is inconvenient.

Referring to FIG. 8, the push unit 95 is installed at an outer side of the through hole of the pivotal end 11 so as to remove the trouble of separating the push unit 95 or to cancel the combining force of the buckling unit 93 of the tool head 92.

### SUMMARY OF THE INVENTION

Accordingly, the primary object of the present invention is to provide a replaceable assembly of a tool head, wherein the defects of difficult connection of the tool head and handle, complicated structure, and weak connection are improved.

In the present invention, the formation of the groove is easy so that the manufacturing process is efficient. In the process, after forming the body of the hand tool. A drill serves to drill the groove with an inclined angle so that the groove is formed as a semi-round shape. Furthermore the cambered side faces toward a head of the tool so that the user can press thereby.

To achieve above objects, the present invention provides a replaceable assembly of a tool head which comprises a tool body used with a tool head of various forms; the tool body having a handle; at least one end of the handle being formed with a pivotal end for connecting the tool head; one end of the tool head being a driving opening and another end thereof being formed with an inserting end which can be combined with the pivotal end; the inserting end being installed with a buckling unit; the buckling unit being buckled to the pivotal end so as to increase the combination of the pivotal end and the pivotal end; thereby the tool head can be firmly secured to one end of the handle; one lateral wall of the pivotal end of the handle having a through hole for buckling the buckling unit of the inserting end of the tool head; a periphery of the through hole being formed with a groove; the groove can be pressed to push the buckling unit of the through hole so that the buckling unit reduced inwards to separate from the through hole so as to take down the tool head.

The various objects and advantages of the present invention will be more readily understood from the following detailed description when read in conjunction with the appended drawing.

### BRIEF DESCRIPTION OF THE DRAWINGS

FIG. 1 is an exploded perspective view of the replaceable assembly of a tool head of the present invention.

FIG. 2 is a perspective view of the replaceable assembly of a tool head of the present invention.

FIG. 3 is a schematic view of the replaceable assembly of a tool head of the present invention.

FIG. 4 is a schematic view about the combination of the replaceable assembly of a tool head of the present invention.

FIG. 5 is an enlarged cross sectional view of the groove of the replaceable assembly of a tool head of the present invention.

FIG. 6 is an enlarged cross sectional view about the operation of the replaceable assembly of a tool head of the present invention.

FIGS. 7, 8 and 9 are schematic cross sectional view about the replaceable assembly of a tool head of the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

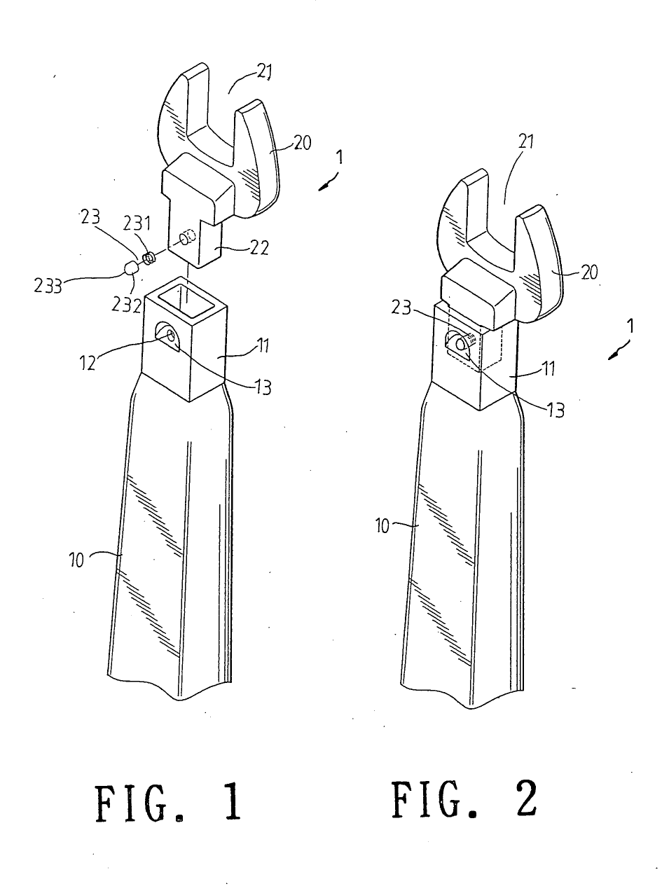

With reference to FIGS. 1 and 2, the replaceable assembly of a tool head of the present invention is illustrated. The present invention has the following elements. A tool body 1 can be used with a tool head 20 of various forms. The tool body 1 has a handle 10. At least one end of the handle 10 is formed with a pivotal end 11 for connecting the tool head 20 (above mentioned is known in the prior art and thus the detail will not be described herein).

One end of the tool head 20 is a driving opening 21 and another end thereof is formed with an inserting end 22 which can be combined with the pivotal end 11. The inserting end 22 is installed with a buckling unit 23. The buckling unit 23 is formed by a spring 231 and a post 232. A front end of the post 232 has a round head. The buckling unit 23 is buckled to the pivotal end 11 so as to increase the combination of the pivotal end 11 and the pivotal end 11. Thereby the tool head 20 can be firmly secured to one end of the handle 10.

One lateral wall of the pivotal end 11 of the handle 10 has a through hole 12 for buckling the buckling unit 23 of the inserting end 22 of the tool head 20. A periphery of the through hole 12 are formed with a groove 13. The groove has a semi-round shape. One inner surface having the through hole 12 is inclined to be pressed easily. The groove 13 can be pressed to push the buckling unit 23 of the through hole 12 so that the buckling unit 23 reduced inwards to separate from the through hole 12 so as to take down the tool head 20. In the present invention, after forming the body of the hand tool, a drill serves to drill the groove with an inclined angle so that the groove is formed as a semi-round shape. Furthermore the cambered side faces to a head of the tool so that the user can press thereby. A straight side of the groove is inclined towards the through hole 12 so that the user's finger can press it easily.

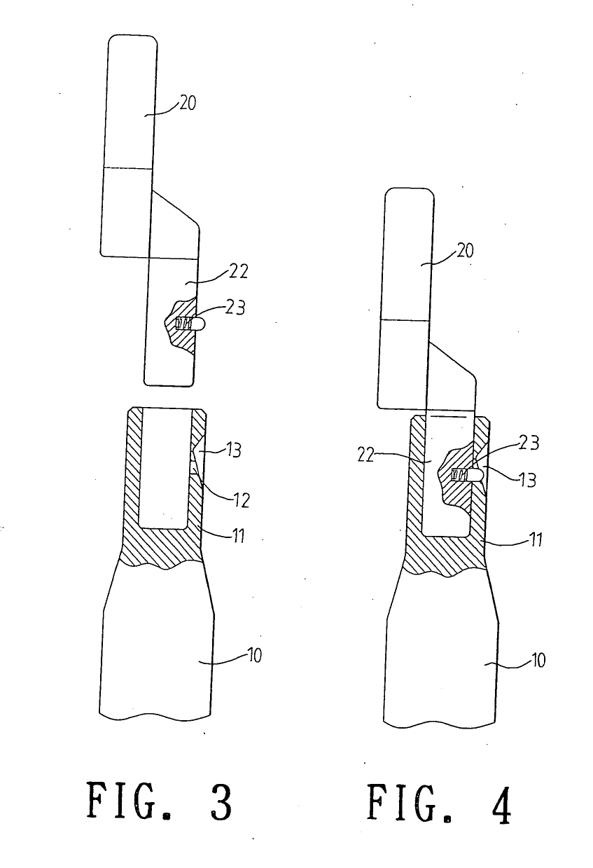

Referring to FIGS. 3 to 6, when it is desired to assemble the tool head 20, the inserting end 22 of the tool head 20 can be inserted into the pivotal end 11. Then the buckling unit 23 of the inserting end 22 will place into the through hole 12 of the pivotal end 11 so that the tool head 20 is combined to the handle 10. Thereby the tool body 1 can lock or release a screw element.

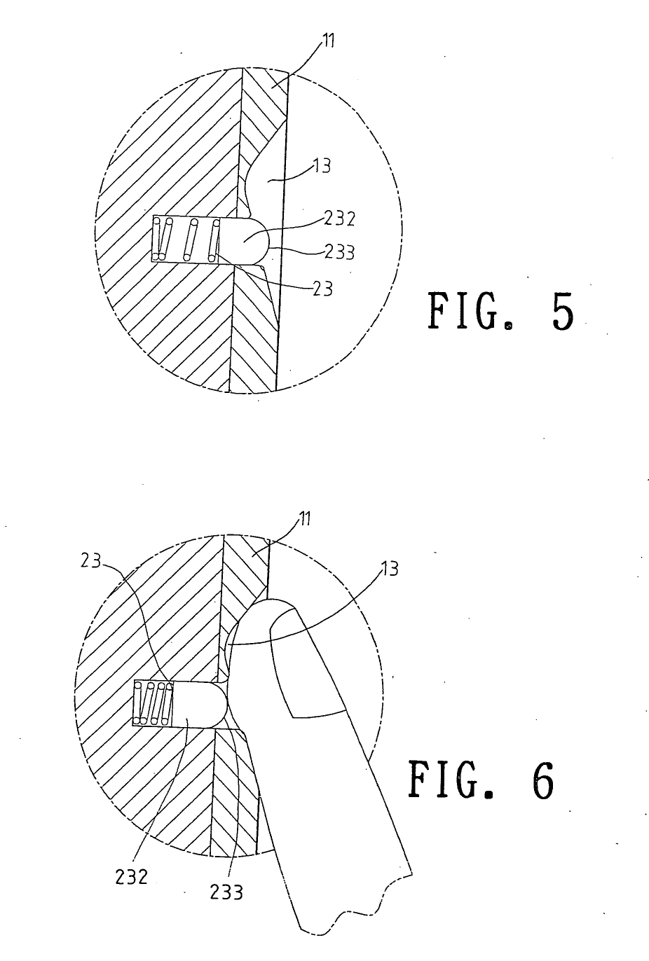

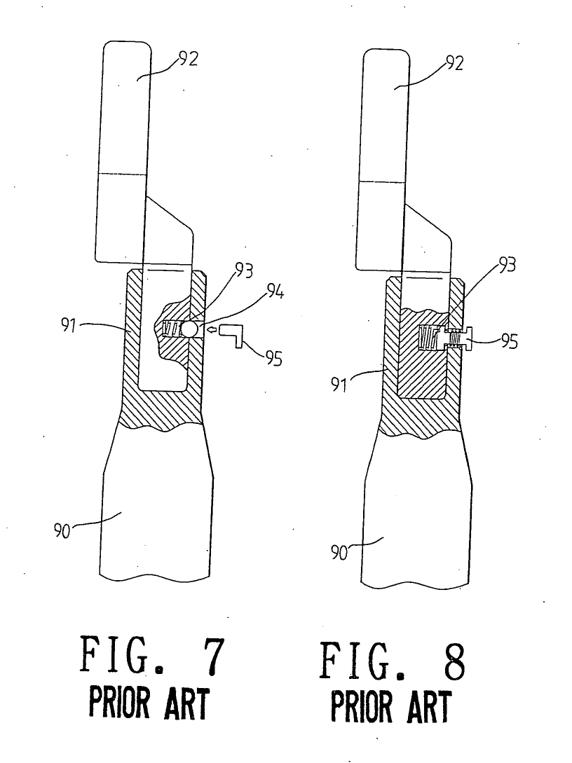

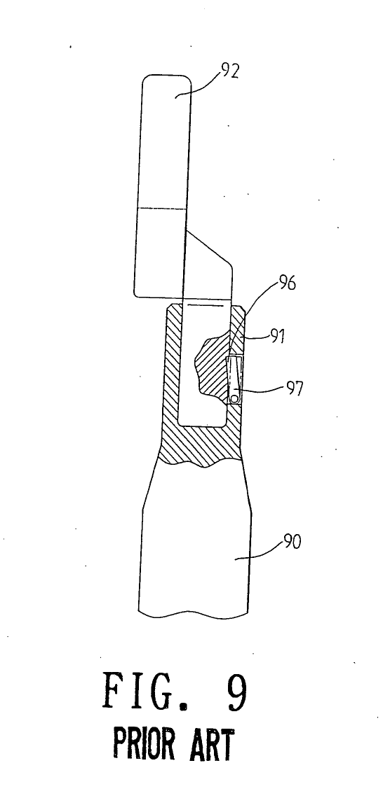

If it is desired to update the tool head 20, the buckling unit 23 of the inserting end 22 can be retracted from the through hole 12 of the pivotal end 11 of the handle 10. Then a finger of the user inserts into the groove 13. The groove 13 is installed at the outer side of the pivotal end 11 and is communicated to the through hole 12. Therefore, as shown in FIG. 6, when the finger inserts into the groove 13, the buckling unit 23 in the through hole 12 will be pushed to be reduced to the inserting end 22 and moves towards the through hole 12 so as to reduce the combining force between the inserting end 22 of the tool head 20 and the pivotal end 11 of the handle 10. Therefore, the front end of the post 232 of the buckling unit 23 is a rounded end 233. It is only necessary to pull the tool head 20 from the pivotal end 11 of the handle 10, the buckling unit 23 will move out of the through hole 12 so as to take down the tool head 20.

Moreover in the present invention, the buckling unit can be formed by a spring and a steel ball.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A replaceable assembly of a tool head comprising:
a tool body used with a tool head of various forms; the tool body having a handle; at least one end of the handle being formed with a pivotal end for connecting the tool head;
one end of the tool head being a driving opening and another end thereof being formed with an inserting end which can be combined with the pivotal end; the inserting end being installed with a buckling unit; the buckling unit being buckled to the pivotal end so as to increase the combination of the pivotal end and the pivotal end; thereby the tool head can be firmly secured to one end of the handle; and
one lateral wall of the pivotal end of the handle having a through hole for buckling the buckling unit of the inserting end of the tool head; a periphery of the through hole being formed with a groove; the groove can be pressed to push the buckling unit of the through hole so that the buckling unit reduced inwards to separate from the through hole so as to take down the tool head.

2. The replaceable assembly of a tool head as claimed in claim 1, wherein the groove has a semi-round shape.

3. The replaceable assembly of a tool head as claimed in claim 1, wherein one inner surface has the through hole being inclined to be pressed easily.

4. The replaceable assembly of a tool head as claimed in claim 1, wherein the buckling unit is formed by a spring and a post; and a front end of the post has a round head.

5. The replaceable assembly of a tool head as claimed in claim 1, wherein the buckling unit is formed by a spring and a steel ball.

6. The replaced assembly of a tool head as claimed in claim 1, wherein the groove is formed as a semi-round shape; and a cambered side of the groove faces toward a head of the tool.
